(19) United States
(12) Patent Application Publication
(10) Pub. No.: US 2015/0153007 A1
(43) Pub. Date: Jun. 4, 2015

(54) LED Light Fitting Facilitating Assembly and Disassembly

(71) Applicants: SHANGHAI SANSI ELECTRONIC ENGINEERING CO.,, Shanghai (CN); SHANGHAI SANSI SCIENCE AND TECHNOLOGY DEVELOPMENT CO., LTD, Shanghai (CN); JIASHAN SANSI PHOTOELECTRIC TECHNOLOGY CO., LTD, Jiaxing, Zhejiang (CN)

(72) Inventors: Bishou Chen, Shanghai (CN); Li Xu, Shanghai (CN); Min Chen, Shanghai (CN); Ling Cai, Shanghai (CN)

(21) Appl. No.: 14/400,123

(22) PCT Filed: Apr. 25, 2013
(86) PCT No.: PCT/CN2013/074687

§ 371 Date: Nov. 10, 2014

(30) Foreign Application Priority Data
May 10, 2012 (CN) 201210145263.2

(51) Int. Cl. F21K 99/00; F21V 19/00; F21V 31/00; F21V 23/06

(52) U.S. Cl. CPC F21K 9/17; F21V 23/06; F21V 19/0025; F21V 31/005; F21Y 2101/02

(57) ABSTRACT

An LED light fitting facilitating assembly and disassembly includes a light fitting casing and a light source module strip installed therein. The light source module strip is in one integral structure that is able to be assembled and disassembled independently in the LED light fitting. The integral structure includes an LED light source and an LED light source installation base. The LED light source installation base is an elongate profile. The light source module strip is inserted into the light fitting casing through a through-hole and fixed with the light fitting casing. The through-hole is sealed with a sealing part. The LED light fitting is able to be installed and removed conveniently by simple plugging and unplugging, neither needing to open the light fitting casing with a relatively large volume nor needing to unscrew a lot of screws using dedicated tools. As a result, an operating procedure is further simplified.

### CROSS REFERENCE OF RELATED APPLICATION

This is a U.S. National Stage under 35 U.S.C 371 of the International Application PCT/CN2013/074687, filed Apr. 25, 2013, which claims priority under 35 U.S.C. 119(a-d) to CN 201210145263.2, filed May. 10, 2012.

### BACKGROUND OF THE PRESENT INVENTION

1. Field of Invention

The present invention relates to an LED lighting field, in particular to an LED light fitting facilitating assembly and disassembly.

2. Description of Related Arts

As a lighting source, LED has such advantages as energy conservation, environmental protection and high efficiency, which has been applied more and more for lighting in multiple occasions. Normal LED light fitting is usually installed by way of mounting and fixing the LED light source on a light fitting casing through a number of screws. This structure is complicated for installation. Especially for a large light fitting, the installation is time and energy consuming, and it is easy to cause installation misalignment during screw tightening. More seriously, it causes damage to the light source. At the same time, it is very inconvenient to remove the LED light source on site in light fitting removal for repair. Moreover, in the applications where there is a high requirement for light fitting protection class, the light fitting casing needs to be in a special form of structure. For example, in case that the light fitting casing adopts a closed structure, installation by way of twisting screws at different locations inside the light fitting casing becomes impossible.

### SUMMARY OF THE PRESENT INVENTION

To solve the above technical problem, the present invention provides an LED light fitting facilitating assembly and disassembly. By adopting an integrated light source structure, installation and removal are able to be realized conveniently between an LED light source module strip and a light fitting casing by simple plugging and unplugging. With no need to open the light fitting casing with a relatively large volume and no need to unscrew a lot of screws using dedicated tools, an operating procedure is further simplified and light fitting installation and removal become more simple and convenient.

To achieve the above goal, the present invention adopts the following technical scheme:

An LED light fitting facilitating assembly and disassembly includes a light fitting casing and a light source module strip installed therein, wherein the light source module strip is one integral structure that is able to be assembled and disassembled independently in the LED light fitting, the integral structure includes a LED light source and an elongate LED light source installation base, wherein the light fitting casing has a slot provided in an inner side wall, wherein the light source module strip is inserted from a through-hole into the slot of the light fitting casing and fixed, and the through-hole is sealed with a sealing part.

The through-hole is located on the light fitting casing.

The light fitting casing has an end cover installed thereon and the through-hole is located on the end cover.

The light source module strip has an electric plug installed thereon and the light fitting casing has a socket matching with the electric plug installed thereon.

The light source module strip has an electric plug installed thereon, wherein the light fitting casing has an end cover installed thereon and the end cover has a socket matching with the electric plug installed thereon.

The light fitting casing and the LED light source installation base are two kinds of elongate tensile profiles coordinating with each other in structure, both of which are connected and fixed in a mode of insertion in slot.

The light fitting casing has an end cover installed thereon, and the end cover has a through-hole provided thereon at a location corresponding to the slot and the LED light source installation base is inserted into the slot through the through-hole and fixed with the light fitting casing.

The sealing part is a sealing plug or a sealing cover.

The light source module strip further includes a circuit board on which the LED light source is soldered and the circuit board is attached onto the LED light source installation base.

The LED light source installation base has a pull provided on one end to facilitate having the pull pulled out of the light fitting casing.

A beneficial effect brought by the present invention is shown below:

The LED light fitting facilitating assembly and disassembly provided in the present invention adopts an independent, removable and integrated light source module strip structure. That light source module strip goes through the through-hole and light fitting installation and removal are able to be fulfilled through simple plugging and unplugging. The advantages brought by this structure are especially reflected in routine maintenance and maintenance to a light fitting in case of abnormal failure in a process that a light fitting has been installed and put into use. In a site of operation where there is a condition limit, the operation will become very convenient with no tool necessary on site. Just open the sealing cover to unplug the light source module strip.

### BRIEF DESCRIPTION OF THE DRAWINGS

FIG. 1 is a structural schematic diagram of an embodiment of the present invention.

FIG. 2 is an exploded structural view of FIG. 1.

FIG. 3 is a structural schematic diagram of a light source module strip as shown in FIG. 1.

FIG. 4 is a structural schematic diagram of one end cover as shown in FIG. 1.

FIG. 5 is a structural schematic diagram of another end cover as shown in FIG. 1.

FIG. 6 is a structural schematic diagram of this embodiment in a removed condition.

FIG. 7 is an exploded structural view of another embodiment of the present invention.

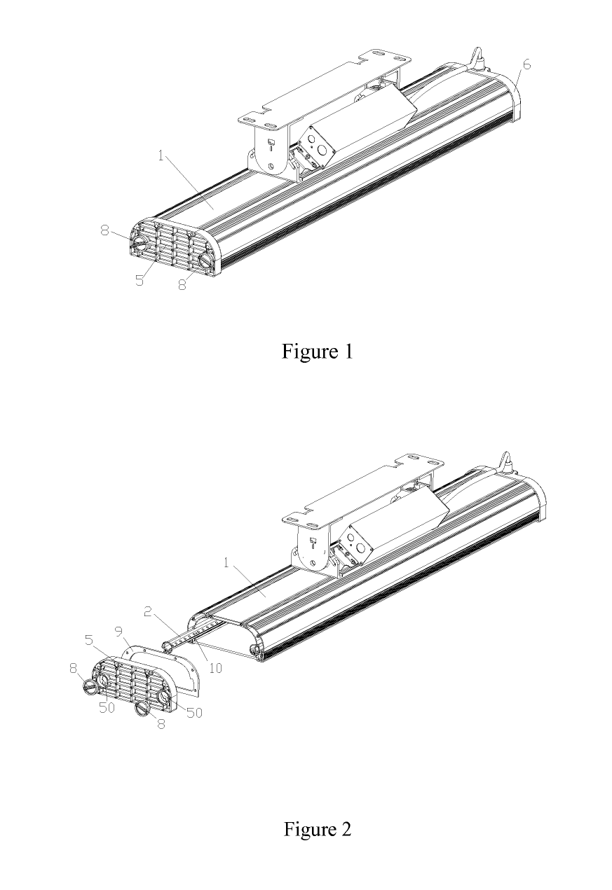

### DETAILED DESCRIPTION OF THE PREFERRED EMBODIMENT

The technical scheme of the present invention will be described in detail below in combination with figures and embodiments.

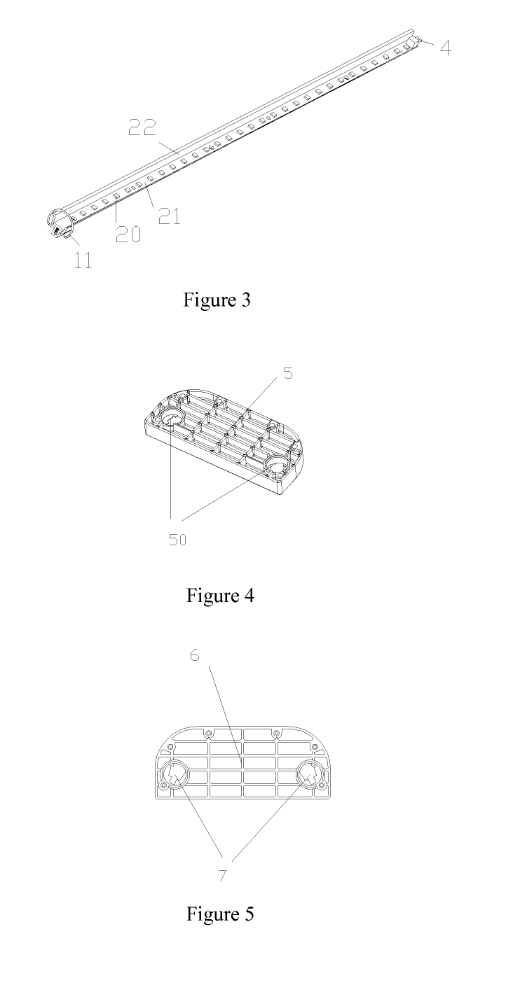

As shown in FIG. 1˜FIG. 3, an LED light fitting facilitating assembly and disassembly provided by the present invention includes a light fitting casing 1 and a light source module strip 2. The LED light fitting in this embodiment is a kind of reflective type LED light fitting. The light fitting casing 1 is an elongate tensile aluminum profile in an arched form and an arched part thereof is in a closed structure. In a tensile direction of the light fitting casing 1, a slot 10 is located near a bottom end of the light fitting casing 1. The light source module strip 2 is in one integral structure that is able to be assembled and disassembled independently in the LED light fitting. The integral structure includes an LED light source 20 and a circuit board 21 on which the LED light source 20 is soldered. The circuit board 21 has an electric plug 4 installed on one end thereof. The circuit board 21 is attached onto an LED light source installation base 22. The light fitting casing 1 has end covers 5 and 6 on both ends respectively, as shown in FIG. 4 and FIG. 5. The end covers 5 and 6 have a gasket 9 installed on inner sides and are fixed on the light fitting casing 1 with screws. The end cover 5 has a through-hole 50 provided thereon. If the LED light source is installed on one side of the light fitting casing, only one through-hole need to be provided. If the LED light source is installed on both sides, two through-holes should be provided. The LED light source installation base 22 is inserted into the slot 10 of light fitting casing 1 through the through-hole 50. To further improve heat dissipation from the light fitting, the LED light source installation base 22 and the light fitting casing 1 must have a contact surface with a certain area between them, so that heat produced by the light source module strip 2 is able to be dissipated out through the light fitting casing 1. The end cover 6 has an electric socket 7 installed on the inner side. After the LED light source installation base 22 is inserted into the light fitting casing 1, the electric plug 4 on the end of the circuit board 21 is inserted into the electric socket 7 exactly to form an electric connection. To facilitate plugging of the LED light source installation base 22 from the slot 10 of the light fitting casing 1 more conveniently, the LED light source installation base 22 has a pull 11 provided on one end. Then, a sealing cover 8 is installed spirally outside the through-hole 50.

The light fitting casing 1 has a light-reflecting film affixed on an inner sidewall of the arched part. A relative position between the LED light source 20 and the light-reflecting film and an arch camber of the light fitting casing 1 is determined by a conventional lighting calculation software according to illumination and a lighting effect actually required, such as a dialux software (a kind of design software applied in a light illumination field to calculate and simulate accurately the lighting effect), or other calculating software.

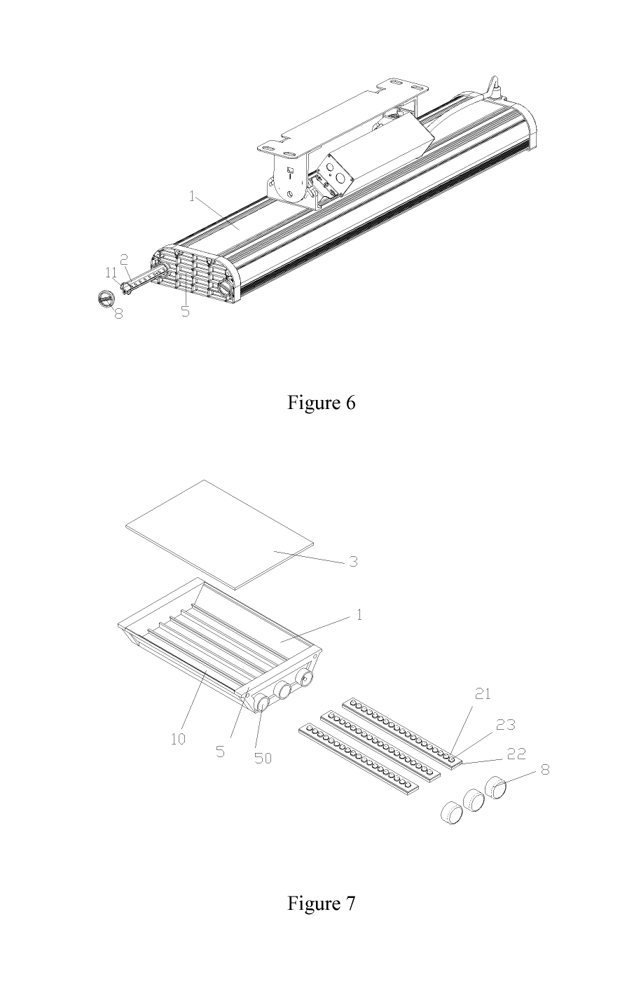

As show in FIG. 6, in removing the LED light fitting provided by the present invention for repair, just unscrew open the sealing cover 8 and then drag the pull 11 on the LED light source installation base 22 to pull the light source module strip 2 out. With no removing tool necessary on site, the operation becomes very easy.

FIG. 7 is an exploded structural view of another embodiment of the present invention. The difference from the above embodiment is that this embodiment is a straight down type LED light fitting. On each LED light source 20 of the light source module strip 2, a lens 23 is provided. A light-emitting surface of the light fitting casing 1 has a glass face shield 3 installed thereon.

What is provided in the above embodiment is an embodiment for a kind of elongate reflective type LED lamp under the technical scheme of the present invention. However, the scope protected by the present invention is not limited to that embodiment. Obviously, the technicians in this field can make various modifications and variations to the embodiments of the present invention without divorcing from the spirit and scope of the present invention. Thus, if these modifications and variations fall within the scope of the claims and equal technology of the present invention, for example, design the light fitting casing into round or square shape or other shapes according to the need of beauty and practicability; have the LED on the LED light source module strip attach directly onto the light source installation base to increase the heat dissipation efficiency, omitting such a layer of structure as circuit board. Then the present invention intends to include these modifications and variations.

What is claimed is:

1. An LED light fitting facilitating assembly and disassembly including: a light fitting casing and a light source module strip installed therein, wherein the light source module strip is one integral structure that is assembled and disassembled independently in the LED light fitting, the integral structure includes an LED light source and an elongate LED light source installation base, wherein the light fitting casing has a slot provided in an inner side wall thereof, wherein the light source module strip is inserted from a through-hole into the slot of the light fitting casing and fixed; the through-hole is sealed with a sealing part.

2. The LED light fitting facilitating assembly and disassembly of claim 1, wherein the through-hole is located on the light fitting casing.

3. The LED light fitting facilitating assembly and disassembly of claim 1, wherein the light fitting casing has an end cover installed thereon and the through-hole is located on the end cover.

4. The LED light fitting facilitating assembly and disassembly of claim 1, wherein the light source module strip has an electric plug installed thereon and the light fitting casing has a socket matching with the electric plug installed thereon.

5. The LED light fitting facilitating assembly and disassembly of claim 1, wherein the light source module strip has an electric plug installed thereon, wherein the light fitting casing has an end cover installed thereon and the end cover has a socket matching with the electric plug installed thereon.

6. The LED light fitting facilitating assembly and disassembly of claim 1, wherein the light fitting casing and the LED light source installation base are two kinds of elongate tensile profiles coordinating with each other in structure, both of which are connected and fixed in a mode of insertion in slot.

7. The LED light fitting facilitating assembly and disassembly of claim 6, wherein the light fitting casing has an end cover installed thereon, and the end cover has a through-hole provided thereon at a location corresponding to the slot and the LED light source installation base is inserted into the slot through the through-hole and fixed with the light fitting casing.

8. The LED light fitting facilitating assembly and disassembly of claim 1, wherein the sealing part is a sealing plug or a sealing cover.

9. The LED light fitting facilitating assembly and disassembly of claim 1, wherein the light source module strip further includes a circuit board on which the LED light source is soldered and the circuit board is attached onto the LED light source installation base.

10. The LED light fitting facilitating assembly and disassembly of claim 1, wherein the LED light source installation base has a pull provided on one end to facilitate having the pull pulled out of the light fitting casing.
